(19) United States
(12) Patent Application Publication
(10) Pub. No.: US 2009/0111448 A1
(43) Pub. Date: Apr. 30, 2009

(54) SYSTEM AND METHOD FOR ENABLING WIDGET INTERACTION

(75) Inventor: Toni Paila, Stamford, CT (US)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/932,183

(22) Filed: Oct. 31, 2007

(51) Int. Cl. H04M 3/00

(52) U.S. Cl. 455/418

(57) ABSTRACT

Methods and systems for transmitting a widget as an interactive component of a broadcast service (e.g., mobile TV broadcast service) in a manner that does not require the widget provider or creator to know or understand the broadcast transmission protocol are described. A widget may be transmitted as a pseudo widget that includes temporary content source information to be replaced by a receiving device with valid content source data. Alternatively or additionally, a content item to be displayed in the widget may be identified by fragment association. That is, a content item may be represented by content and access fragments while a widget may be transmitted as an interactivity fragment. These fragments may be associated with one another such that a content fragment may be identified by inspecting an interactivity fragment and vice versa.

### TECHNICAL FIELD

The invention relates to generally to a system and method for facilitating the transmission of and interaction with applications.

### BACKGROUND

Interactive applications that provide various types of information to user devices are becoming increasingly popular as ways to receive discounts, audio/video content, news and other information without having to proactively access a content source. Typically, interactive applications such as widgets are executed on a device and will alert or deliver content to the user at predefined times. Interactive widgets generally operate independently of other content access applications such as web browsers. One type of content that may be delivered through widgets is broadcast programming such as television programs and/or radio shows. However, broadcast programming is generally delivered using various predefined standards and broadcast protocols. Thus, interactive widgets configured to deliver such content must be created such that they are compatible with the various standards and protocols. Such an endeavor requires widget providers to know and understand all the different broadcast standards for maximum compatibility.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Aspects described herein generally relate to systems and methods for transmitting a widget as an interactive component of a broadcast service. Such methods and systems may be used in various environments such as when a widget includes the display of broadcast programs. Widgets refer to applications that are configured to convey various types of information from a content provider to a user's device. Typically, widgets operate independently of a browser application such as MICROSOFT INTERNET EXPLORER, OPERA, MOZILLA FIREFOX, or NOKIA S60 Browser. Alternatively or additionally, widget may use or be developed using other application programming interfaces (API) developed by YAHOO, GOOGLE, NOKIA WEB RUN-TIME and the like. Further, widgets may also include content source information in a content source parameter that identifies a content to be rendered through the widget as well as the content's access information (e.g., location). In one configuration, a widget may be transmitted through a broadcast service defined by multiple service fragments or descriptors. For example, a broadcast service may define an interactivity fragment to specify that a broadcast includes an interactive component and to identify that interactive component. A content program broadcast in the broadcast service may be represented by a content fragment and an access fragment wherein the content fragment corresponds to a content program ID and the access fragment corresponds to information for accessing the content program. The fragments may be associated with each other such that a receiving device may identify an associated content program using the interactivity fragment.

According to one aspect, a pseudo widget corresponding to a widget may be created for transmission through a broadcast service. A pseudo widget may include all functional information except for a valid content source parameter. That is, the content source parameter might not be useable by the pseudo widget to access the content to be rendered in the widget. Instead, the pseudo widget may include temporary content source information that is later translated and replaced by a receiving device. Thus, the pseudo widget may be converted into a functional widget upon replacement of the temporary content source information with valid content source data. Content source information or data generally refers to access and/or identification information for identifying and/or accessing content to be rendered in the widget. In one or more arrangements, temporary tag information may include a temporary tag for identifying the information as temporary, a matching field for identifying the field with which a field value is to match and the field value. The matching field may be defined as, for example, a content name or ID field while the field value may specify the content name or ID.

According to another aspect, a widget provider may specify an interaction time of the widget. An interaction time may indicate a time at which the widget is to be transmitted to or executed by a receiving device.

### BRIEF DESCRIPTION OF THE DRAWINGS

Certain embodiments are illustrated by way of example and not limited in the accompanying figures in which like reference numerals indicate similar elements and in which:

FIG. 1 illustrates a block diagram of a communication network in which one or more embodiments may be implemented.

FIG. 2 is a block diagram of a communication device according to one or more aspects described herein.

FIG. 3 illustrates an interactive widget displayed in a user interface according to one or more aspects described herein.

FIG. 4 is a flowchart illustrating a method for making an interactive widget available through an interactivity component of a broadcast according to one or more aspects described herein.

FIG. 5 is a flowchart illustrating a method for configuring a widget for broadcast and delivery through a broadcast service according to one or more aspects described herein.

FIG. 6 is a flowchart illustrating a method for receiving and processing an interactive widget through a broadcast service according to one or more aspects described herein.

FIG. 7 illustrates a broadcast service fragments and a corresponding widget according to one or more aspects described herein.

### DETAILED DESCRIPTION OF THE INVENTION

In the following description of the various embodiments, reference is made to the accompanying drawings, which form a part hereof, and in which are shown by way of illustration various embodiments in which the invention may be practiced. It is to be understood that other embodiments may be utilized and structural and functional modifications may be made without departing from the scope of the present invention.

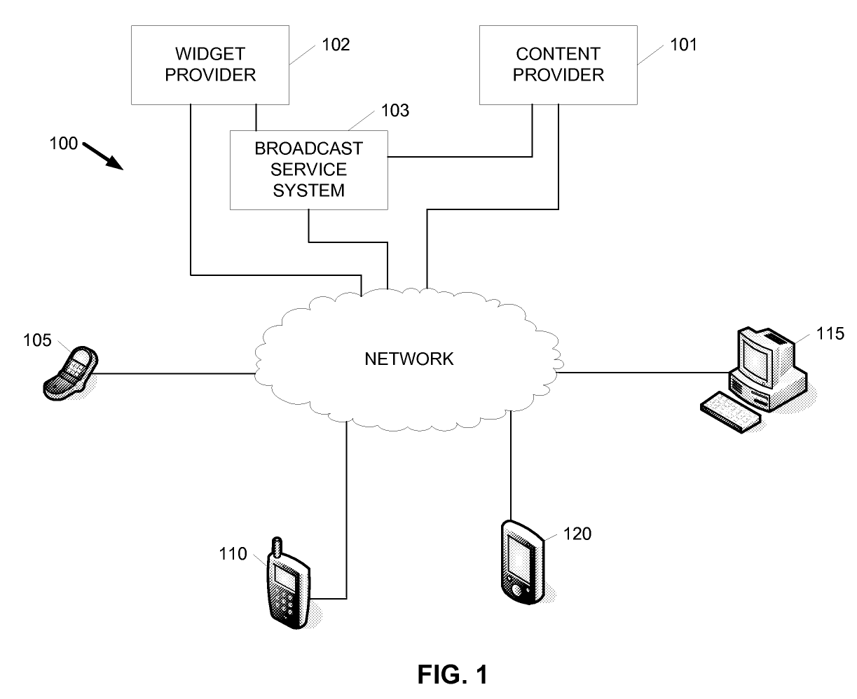

Various embodiments may be used in a broad array of networks and communication protocols. FIG. 1 illustrates an example of a communication network through which content may be downloaded according to one or more aspects described herein. Specifically, communication network 100 includes content provider 101, widget provider 102, broadcast service system 103, mobile communication devices 105 and 110, personal computer (PC) 115 and personal data assistant (PDA) 120. PC, as used herein, is not limited to any particular operating system or platform. Communication through network 100 is not limited to the illustrated devices and may include other apparatuses such as a home video storage system, a portable audio/video player, a digital camera/camcorder, a positioning device such as a GPS (Global Positioning System) device, a mobile television, a STB (Set-top Box), a digital video recorder, and the like and in any combination of the aforementioned.

Devices 105, 110, 115 and 120 may be connected to each other and to content provider 101, widget provider 102 and broadcast service system 103 through various types of networks. For example, mobile communication devices 105 and 110 may communicate with content provider 101 through a cellular network, a short range communication connection (such as a Bluetooth®, UWB (Ultra Wide Band), infrared, WiBree), a wireless local area network (WLAN) and/or a high-speed wireless data network, e.g., Evolution-Data Optimized (EV-DO) networks, Universal Mobile Telecommunications System (UMTS) networks and/or Enhanced Data rates for GSM Evolution (EDGE) networks. In one or more arrangements, mobile communication devices 105 and 110 and other devices like PC 115 and PDA 120 may communicate using a wired network communication. Further, devices 105, 110, 115 and 120 may use various communication protocols such as Internet Protocol (IP), Transmission Control Protocol (TCP), Simple Mail Transfer Protocol (SMTP) among others known in the art.

Content provider 101 and widget provider 102 may be configured to distribute information (e.g., video, audio, applications) through broadcast service system 103. Broadcast service system 103 may, for example, configure a broadcast service and session for advertising and transmitting various content items and interactive services to subscribing devices. Thus, in various instances, content provider 101 and/or widget provider 102 may send content and services to broadcast service system 103 for broadcasting to one or more of devices 105, 110, 115 and 120. In one or more arrangements, broadcast service system 103 may be configured to broadcast content and services using OMA BCAST (Open Mobile Alliance Mobile Broadcast Services Enabler Suite) protocol and services. While content provider 101, widget provider 102 and broadcast service system 103 are illustrated as separate entities in FIG. 1, it is to be understood that systems 101, 102 and 103 may be modules or components of a single system.

Additionally or alternatively, content and interactive services may be broadcast in two different channels of a broadcast service. Thus, content may be broadcast in a content broadcast delivery channel while interactive data such as a widget or pseudo widget may be broadcast in a separate interactivity delivery channel. Thus, if interactive data references a content item broadcast in the content broadcast delivery channel, a device may need to locate and/or identify the content item in the content broadcast delivery channel.

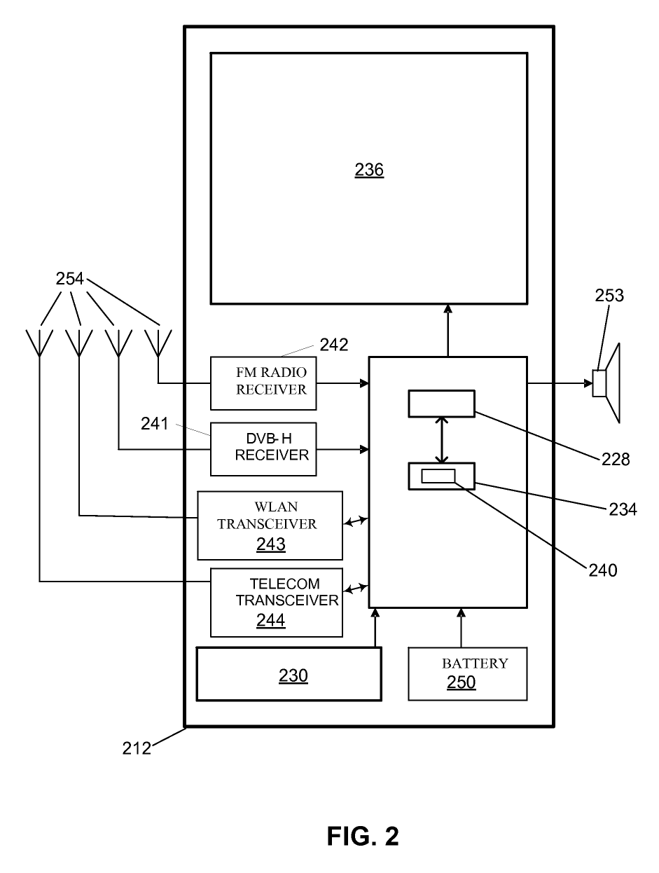

FIG. 2 is a block diagram of a communication device such as mobile communication device 105 including processor 228 connected to user interface 230, memory 234 and/or other storage, and display 236. Communication device 212 may also include battery 250, speaker(s) 253 and antennas 254. User interface 230 may further include a keypad, touch screen, voice interface, one or more arrow keys, joy-stick, data glove, mouse, roller ball, or the like. Communication device 212 may comprise a computer, PDA, mobile telephone and the like.

Computer executable instructions and data used by processor 228 and other components within communication device 212 may be stored in a computer readable memory 234. The memory may be implemented with any combination of read only memory modules or random access memory modules, optionally including both volatile and nonvolatile memory. Software 240 may be stored within memory 234 and/or storage to provide instructions to processor 228 for enabling communication device 212 to perform various functions. Alternatively, some or all of communication device 212 computer executable instructions may be embodied in hardware or firmware (not shown).

Communication device 212 may be configured to receive, decode and process digital radio or television broadcast transmissions that are based, for example, on the DVB (Digital Video Broadcasting) standards, through a specific DVB receiver 241. The mobile device may also be provided with other types of receivers for digital broadcast transmissions, such as ATSC (Advanced Television Systems Committee), MediaFLO, DMB (Digital Multimedia Broadcasting), ISDB (Integrated Services Digital Broadcasting), HDTV (High-definition television), DAB (Digital Audio Broadcasting), DRM (Digital Radio Mondiale), etc. Additionally, communication device 212 may also be configured to receive, decode and process transmissions through FM/AM Radio receiver 242, WLAN transceiver 243, and wireless telecommunications transceiver 244. Transceivers 243 and 244 may, alternatively, be separated into individual transmitter and receiver components (not shown). In one example, transceiver 244 may include a broadcast receiver (not shown) and a backward channel receiver (not shown) for communicating over the broadcast channel and the backward channel, respectively.

According to one aspect, communication device 212 may receive Radio Data System (RDS) messages. Other transmission and reception systems may also be used including BLUETOOTH®, WiMAX (Worldwide Interoperability for Microwave Access) i.e., Institute of Electrical and Electronics Engineers (IEEE) 802.16 standard, and/or UWB (Ultra-wideband) transceivers. In one or more instances, signals may be transmitted to and received from another mobile terminal (not shown). For example, audio, video and other signals may be transmitted between two communication devices using various transmissions protocols such as wireless local area networks (WLANs), General Packet Radio Service (GPRS), third generation mobile system technology (3G), Bluetooth and/or Universal Plug and Play (UPnP). Such networks may be used to access or support local networks or remote networks such as the Internet.

Referring again to FIG. 1, widget provider 102 stores, configures and distributes widgets to users. Widgets, as used herein, generally refer to applications that provide content from a content provider such as content provider 101 to a user's device. A widget may run on a user's device and automatically receive and display new content from one or more content providers. A widget may further operate independently of other content access applications such as web browsers existing on the user's device. In one example, a widget may be sponsored by a company that may use the widget to notify users of discounts or sales. Additionally, widgets may include interactive features. For example, a widget may include options for launching a web browser for navigating to a particular site in response to a user selecting a widget option. Widgets may be a variety of sizes, shapes and configurations.

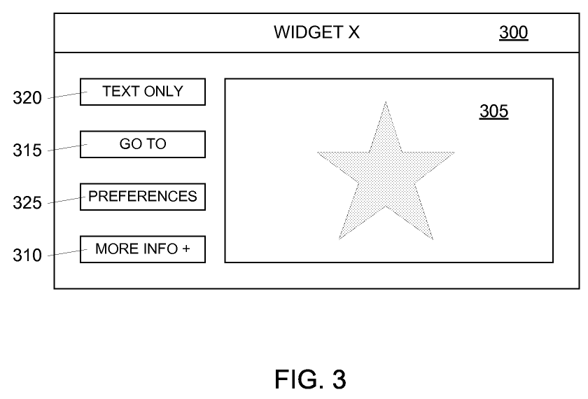

FIG. 3 illustrates a widget 300 having a content display area and including various options and features for customizing widget 300. For example, widget 300 includes a content display area 305 where video, images, text and other types of content may be rendered. Widget 300 further includes more information option 310, go to option 315, text only option 320 and preferences option 325. More information option 310 may be selected by a user if the user wishes to see additional information relating to content currently displayed in content display area 305. Selecting more information option 310 may cause an information pane (not shown) to be revealed. More information option 310 may change in appearance depending on whether the information pane is shown or not. For example, more information option 310 may resemble a plus sign (i.e., ‘+’) when the additional information is not being displayed and a minus sign (i.e., ‘−’) when the additional information is being displayed.

Go to option 315 may be used to access a website or other content site associated with content displayed by widget 300. For example, a car advertisement may be displayed by widget 300 in content display area 305. If a user is interested in the car being advertised or the car company, the user may select go to option 315, which may automatically launch a web browser and navigate to a predefined site (e.g., the car company's website). A browsing application such as a web browser may be pre-associated with the widget based on an operating system default, user preference, widget default and/or content parameters.

Text only option 325 allows a user to display only text so that video and images are not shown. A user may wish to disable video and image content in a work environment or where video and/or audio may be distracting to others. Preferences option 320, when selected, may reveal a preferences menu where users may select various options and features of the widget or content displayed therein that they wish to activate or deactivate. Preference options may include widget size, content rating, advertisements per hour (or per other time period), audio and the like.

In one or more instances, widgets may be used to deliver broadcast programming such as television or radio programming generally broadcast according to various predefined standards or protocols such as OMA BCAST. Thus, according to one aspect, interactive widgets may be transmitted according to the broadcast protocol of the content with which the interactive widgets are associated. Such a method eliminates the need for widget developers and providers to develop widgets specifically for compatibility with one broadcast protocol or another. Instead, various parameters of a widget may be configured after the widget has been developed to suit a particular broadcast protocol such as OMA BCAST.

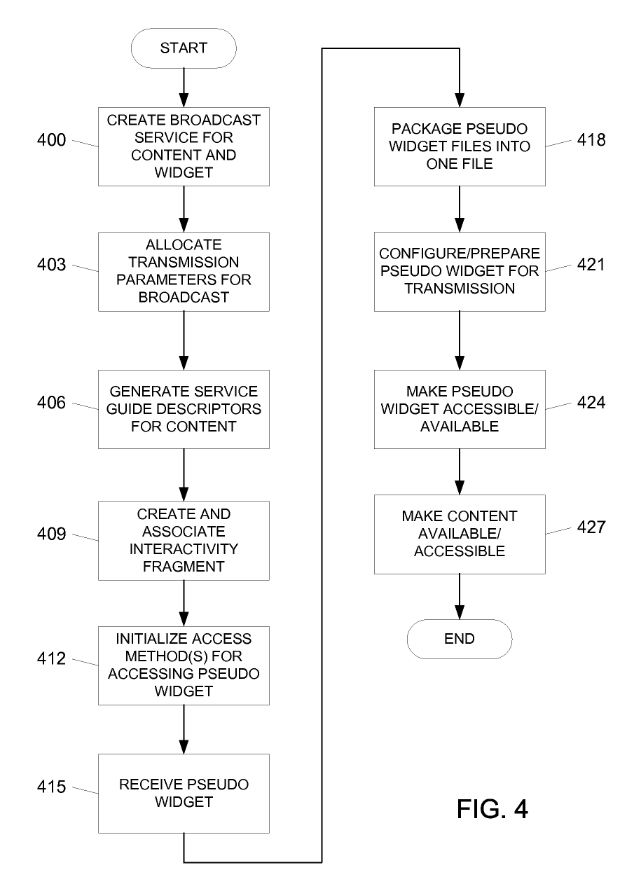

FIG. 4 is a flowchart illustrating a method for broadcasting an interactive widget associated with broadcast content as a pseudo widget to one or more devices. A pseudo widget is a replica or variation of a functional widget except for the inclusion of a temporary content source parameter. The functional widget may in one embodiment be interactive. Generally, a functional widget includes content source information that is useable by a processing device such as a mobile phone to retrieve and access the content. In a pseudo widget, however, the content source information includes a placeholder or temporary data that might not be useable for accessing the content. In step 400, a broadcast service system may create a broadcast service for the content associated with the pseudo widget corresponding to the interactive widget. For example, if an interactive widget is configured to display a mobile television channel or television program, a broadcast service may be created for broadcasting that mobile television channel or television program. Stated differently, the broadcast service system may make the mobile television channel or program available through a broadcast service (e.g., a content broadcast channel of the broadcast service).

Once the broadcast service has been created, the broadcast service system may allocate transmission parameters for broadcasting the content in step 403. In one example, the transmission parameters may be specified in a file according to Session Description Protocol (SDP). Information relating to SDP may be found at RFC 2327 (downloadable at http://www.ietf.org/rfc/rfc2327.txt?number=2327). In another example, the transmission parameters may be presented as Program Specific Information/Service Information (PSI/SI) for example according to DVB or other broadcasting standards. Examples of transmission parameters may include identification of a transport protocol, a media format/codec, a multicast/unicast address/port and/or timing (start/stop) information. In step 406, service guide descriptors or fragments may be generated for identifying and describing the content being broadcast. Descriptors may include fragments such as a content fragment used to identify a content item (e.g., a number or name of the content) and an access fragment that specifies an access address, location or method for retrieving or otherwise acquiring the content. Fragments, as used herein, generally refer to parameters for defining various aspects or components of a broadcast service. According to one or more aspects, temporary content source information corresponding to temporary content source information stored in a pseudo widget (as described below) may also be stored in an access fragment or other service guide descriptor.

In step 409, an interactivity fragment (e.g., InteractivityData fragment of OMA BCAST) may be created and associated with the fragments created in step 406 to specify that interactive services or documents such as the pseudo widget are associated with the broadcast content. According to one aspect, fragments may be transmitted as part of an electronic service guide (ESG) over a broadcast content delivery channel or over an interactivity delivery channel of a broadcast service. The availability of ESG fragments may be declared in the transmission parameters such as a Service Guide Delivery Descriptor (SGDD). Further, in one embodiment, fragments may be delivered in one or more Service Guide Delivery Units (SGDU) using FLUTE (File Delivery over Unidirectional Transport) as a delivery protocol. Information regarding FLUTE may be found at RFC 3926, downloadable at http://www.ietf.org/rfc/rfc3926.txt?number-3926 protocol. If the fragments are delivered over the interactive delivery channel, they may be requested by the terminal. If, on the other hand, the fragments are delivered over the broadcast content delivery channel the terminals may receive the fragments via polling.

In step 412, one or more methods for accessing the pseudo widget may be initialized. Access methods may include a broadcast session for broadcasting the pseudo widget to one or more devices. For example, a pseudo widget may be broadcast as one interactive component of a broadcast service (e.g., an instance of InteractiveMediaDocuments using the OMA BCAST protocol). Alternatively or additionally, an access location for allowing a device to retrieve the pseudo widget may be defined. For example, the access location may include a URL that devices may access via Hypertext Transfer Protocol (HTTP). In step 415, the pseudo widget may be received or retrieved from a widget provider.

As discussed, the pseudo widget may include temporary content source information. In one or more arrangements, the temporary content source information may be used to locate and retrieve valid access information for accessing the content to be rendered in the widget. Temporary content source information may be used so that a widget provider does not need to know or understand the underlying transmission protocol. Instead, a receiving device that understands the broadcast protocol may process the temporary content source information, obtain valid access information using the temporary content source information and replace the temporary information with the valid content access data, as discussed in further detail below. In one example using OMA BCAST broadcast protocols, temporary content source information may be formatted as a string having a tag indicator, a matching field and a field value. The tag indicator is used to indicate that the content source information in the pseudo widget is not valid content source data (i.e., it cannot be used to access the content). The matching field, on the other hand, specifies the attribute of a content fragment or access fragment storing a value that is to match the field value. According to one arrangement using OMA BCAST broadcast methods, the matching field may be a content or service ID attribute such as GlobalContentID or GlobalServiceID. One example of temporary content source information includes a text string such as “!!!TEMP-TAG&ContentName&Smurffit,” where!!!TEMP-TAG is the tag indicator, ContentName is the matching field and Smurffit is the field value. In one or more instances, the temporary tag information may be provided by the broadcast service system. Thus, the widget provider only needs to know the temporary tag information and other data such as access information may be derived using the temporary tag information.

According to one aspect, the matching field and field value may be omitted. Instead, a terminal may identify the content using fragment associations (e.g., associations or links between an InteractivityData fragment and Content and Access fragments). In step 418, if a pseudo widget includes multiple files, the widget may be packaged into a single file for transport. For example, the multiple widget files may be included in a single GNU zip (GZIP) file for easier transport.

Once the pseudo widget has been received, the broadcast service system may configure or package the pseudo widget for storage and transport in step 421. In one example, the broadcast service system may instantiate an interactive service object for transmitting the pseudo widget in the broadcast session. In an OMA BCAST broadcast system, the interactive service object may correspond to a MediaObjectSet element of an instance of InteractiveMediaDocuments. Various parameters of the transport package (e.g., the interactive service object) may also be defined prior to making the pseudo widget available to users. For example, a content-type parameter may be set to “application/x-gzip” to identify the type of data stored therein while a content-location may be set to location at which the widget may be accessed (e.g., a uniform resource identifier). Additionally or alternatively, using OMA BCAST protocols, each file associated with the pseudo widget may be defined as a separate instantiation of an Object element of MediaObjectSet.

Once the broadcast session and the pseudo widget transport package have been configured, the broadcast service system may make the pseudo widget (e.g., the widget GZIP file) accessible to one or more devices in step 424. The pseudo widget may be made available via the access method or methods initialized in step 412. Further, in step 427, the content associated with the pseudo widget may also be made available (e.g., through broadcast or on-demand access) as defined by the transmission parameters specified in step 403.

As discussed with respect to FIG. 4, a pseudo widget may be configured by and received from a widget provider. A widget provider may be a component of the broadcast service system or may be operated by a separate entity.

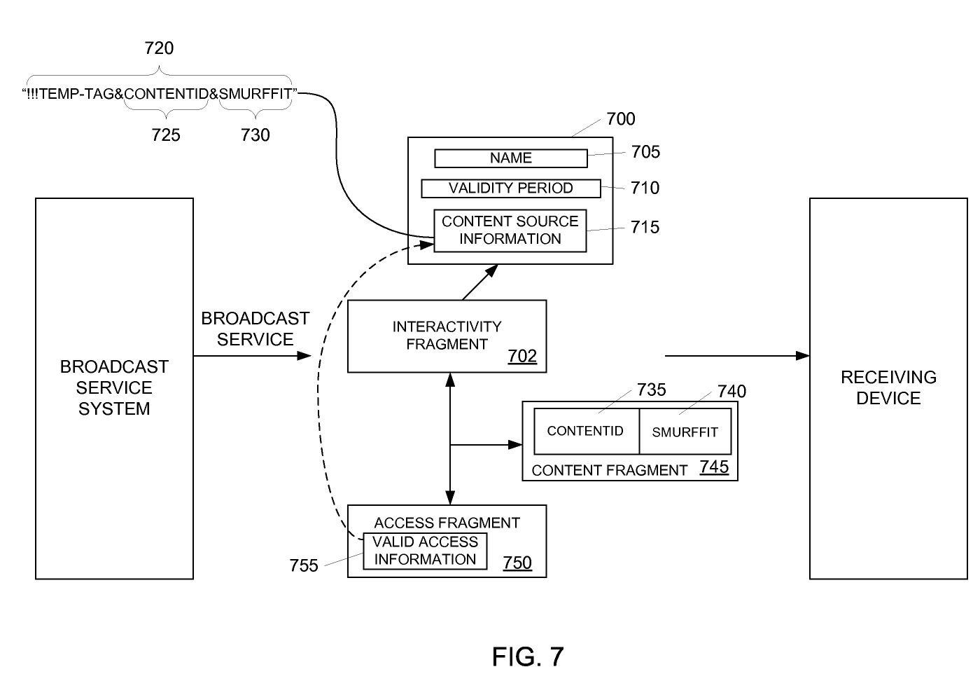

FIG. 7 illustrates a pseudo widget and various broadcast service fragments used to define various parameters and components of a broadcast through which the pseudo widget is transmitted. An interactivity fragment 702 may identify an interactive component of a broadcast such as pseudo widget 700. Pseudo widget 700 may include various parameters such as a name parameter 705, a validity parameter 710 and a content source parameter 715. Name parameter 705 may be used to specify a name of the widget while validity parameter 710 may be used to indicate a period in which the pseudo widget is valid to operate. Content source parameter 715 may be used to store access information for accessing content to be rendered in a widget. In a pseudo widget such as pseudo widget 700, however, content source parameter 715 includes temporary source information that is generally not valid for accessing a content item. Instead, the temporary source information stored in content source parameter 715 allows a device to locate and acquire valid content access information. For example, content source parameter 715 may store text string 720 that identifies itself as temporary tag information by the “!!!TEMP-TAG” string. To obtain the access information for the content item that is to be rendered, a receiving device may match the matching field 725 and field value 730 with a corresponding field 735 and field value 740 of content fragment 745. Content fragment 745 and access fragment 750 may be associated such that identification of content fragment 745 allows a receiving device to identify access fragment 750 as the corresponding access information. According to one aspect, interactivity fragment 702 and/or pseudo widget 700 may be transmitted over an interactivity channel (not shown) of the broadcast service while content fragment 745 and/or access fragment 750 may be transmitted over a content broadcast channel (not shown) of the broadcast service.

Valid access information 755 for the content item corresponding to content fragment 745 and access fragment 750 may then be extracted from either content fragment 745 or access fragment 750 or both. Valid access information 755 may then be used to replace the temporary content source information that was initially included in the pseudo widget. Upon replacement, the pseudo widget may be converted to a functional widget that is able to access and retrieve the content item using valid access information 755. Additionally or alternatively, each of interactivity fragment 702, content fragment 745 and access fragment 750 may be linked or otherwise associated. Thus, a device or application having knowledge of an interactivity fragment 702 may be able to locate and identify an associated content fragment (e.g., in a broadcast content delivery channel) such as content fragment 745 via such links.

As discussed, fragments may be retrieved over an interactivity delivery channel or received over a broadcast content delivery channel via polling. A combination of the two receiving/retrieval methods may also be used. Further, any number of fragments may be received/retrieved by a receiving device. For example, a receiving device may receive one, two, four or seven fragments depending on what is made available by a broadcast service system and/or what is needed by the receiving device.

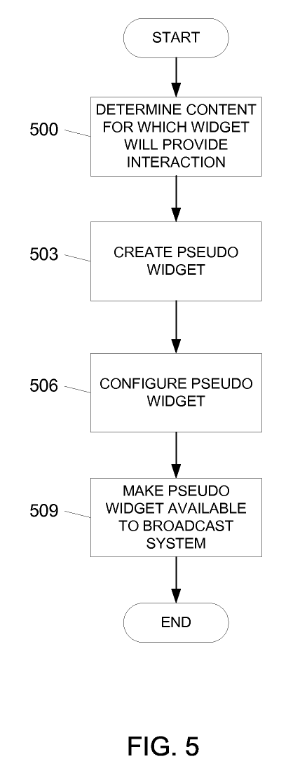

FIG. 5 is a flowchart illustrating a method for creating and configuring a pseudo widget for transmission over a broadcast service. In step 500, a widget provider may determine or identify a content or service for which a widget will provide interaction. Such a determination may be made manually or automatically based on, for example, a relevance between the interactive widget and a particular content item. In one example, a car advertisement widget may be associated with a car review television program to maximize a relevance and interest to the receiving audience. According to one or more configurations, the widget provider may also determine a timing for interaction (e.g., a point during the broadcast at which the widget or a pseudo widget corresponding thereto is to be distributed or made available to one or more receiving devices). The timing may be relational (e.g., relative to the beginning or end of the content item) rather than absolute. Alternatively, the timing may also be defined in absolute times.

In steps 503 and 506, the widget provider may create and configure a pseudo widget corresponding to the interactive widget. In one or more configurations, the widget provider may convert the interactive widget into a pseudo widget by including temporary content source or tag information in a content source parameter of the widget. Thus, the pseudo widget may be executable/renderable except for a source parameter that is used to access and launch a content item. As discussed, temporary content source information may include a temporary tag indicator, a matching field and a field value. However, in one or more instances, the matching field and the field value may be omitted depending on whether fragment associations exist between the fragments of the broadcast service (e.g., between an interactivity fragment and a content or access fragment). Once the pseudo widget has been configured, the pseudo widget may be made available to the broadcast service system in step 509. For example, the widget provider may transmit the pseudo widget or a notification to the broadcast service system.

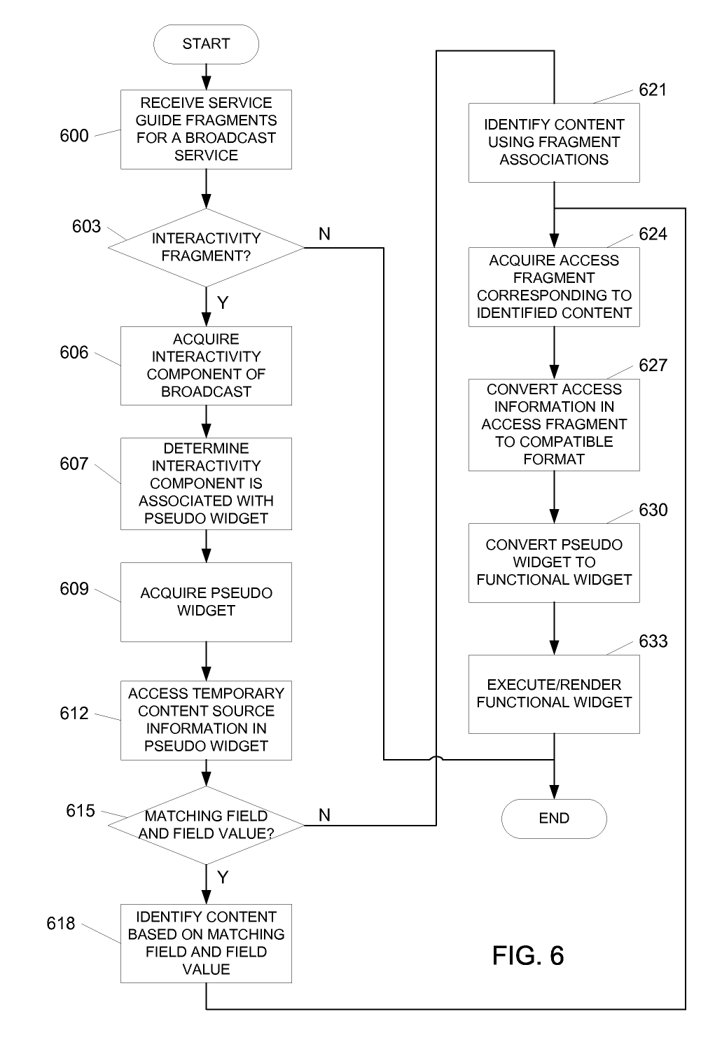

FIG. 6 is a flowchart illustrating a method for receiving a pseudo widget through a broadcast service and for converting the pseudo widget into a widget able to access and render associated content. In step 600, a receiving device such as mobile communication device 105 or 110 may receive service guide fragments or descriptors for a broadcast service from the broadcast service system. The receiving device may acquire the service guide fragments either by broadcast or by retrieving the fragments from an access location. In step 603, the receiving device may determine whether the broadcast service includes an interactive component. For example, the receiving device may determine whether an interactivity fragment is included in the retrieved fragments. In the case of OMA BCAST broadcasts, the receiving device may determine whether an InteractivityData fragment exists. If an interactive component does not exist, the process may end. If, however, an interactive fragment does exist, the receiving device may acquire (e.g., receive by broadcast or retrieval), in step 606, a corresponding interactivity component that identifies the interactive content, application or service (e.g., an OMA BCAST InteractivityMediaDocument declaring a GZIPed pseudo widget). In step 607, the receiving device may determine that a pseudo widget is included in or referenced by the interactive component. In response, the receiving device may acquire the pseudo widget associated with the interactivity component in step 609.

In step 612, the receiving device may then access the one or more widget files of the received pseudo widget to extract temporary content source information stored in the one or more widget files. In step 615, the receiving device may determine whether a matching field and field value are specified in the temporary content source information. If so, the receiving device may identify and locate a corresponding content or service fragment using the matching field and field value in step 618. For example, the matching field and field value may be compared to various service and content fragments being broadcast by a broadcast system to identify a match (as discussed in FIG. 7). If, however, the temporary content source information does not include a matching field and field value (e.g., the temporary content source information includes only the tag indicator), the receiving device may identify an appropriate content or service fragment through fragment relationships in step 621. For example, the content, interactivity and access fragments might each include identification information of each of the other fragments. Alternatively or additionally, each fragment may include a link to each of the other fragments. In one example, an interactivity fragment may include a reference to a content fragment and or to a service fragment as a sub-element of the interactivity fragment. The sub-elements of a fragment may further include an identification of the content fragment or the service fragment as an attribute.

Once the appropriate content or service fragment has been identified, the receiving device may identify and acquire a corresponding access fragment in step 624. As discussed, an access fragment includes information for accessing a corresponding content or service. In step 627, the receiving terminal may convert the access information specified in the access fragment into a widget compatible source tag format. For example, a widget might only understand or be able to process content locations specified as a URL. Thus, if the access information is expressed in some other format, a conversion or translation may be performed to convert the access information from the first format into a second format (i.e., URL format). Widgets may use a variety of formats. In some instances, widgets may use a form of URL syntax for accessing content items. An example format that may be used for compatibility with APPLE QUICKTIME content is as follows:

<object CLASSID=
“clsid:02BF25D5-8C17-4B23-BC80-D3488ABDDC6B”
CODEBASE=“http://www.apple.com/qtactivex/qtplugin.cab”
width=“360” height=“240”>
<param name=“src” value=“1.jpg”>
<param name=“autoplay” value=“true”>
<param name=“controller” value=“false”>
<param name=
“href” value=“rtsp://quicktime1.oit.duke.edu/video/ddi_webcast.sdp”>
<param name=
“target” value=“QuickTimePlayer”>
<embed src=“1.jpg” width=“360” height=
“240” type=“video/quicktime” controller=“false”
autoplay=“true” href=
“rtsp://quicktime1.oit.duke.edu/video/ddi_webcast.sdp”
target=“QuickTimePlayer”
pluginspage=“http://www.apple.com/quicktime/download/”
name=“Get QuickTime”>
</object>

Other examples access information formats may be found at http://www. oit.duke.edu/dms/dukestream/live_streaming_sample_links.html.

Once the access information has been properly formatted, the receiving device may convert the pseudo widget into a functional widget by replacing the temporary content source information with the converted or translated access information in step 630. For example, the converted access information may be stored over the temporary content source information in the content source parameter of the pseudo widget. Once the content source information has been replaced with a valid source tag, the receiving device may execute or render the converted widget in step 633. According to one or more aspects, the interactive functional widget may be executed/rendered at a predefined time specified by the broadcast service. For example, the widget may be executed at a time scheduled for broadcasting an associated content program (e.g., a television program).

In one or more configurations, the receiving device may directly identify and/or locate the access fragment if the interactivity fragment is linked or otherwise associated to the access fragment; rather than identifying the content fragment and subsequently identifying the access fragment. That is, step 621 of the method illustrated in FIG. 6 may be optional.

According to one or more further aspects, a pseudo widget may be resident in a receiving device. That is, a receiving device may have downloaded or received a pseudo widget from a widget provider directly or through a medium other than a broadcast network carrying corresponding content. In such a case, the receiving device may process (e.g., convert) the pseudo widget according to the methods and systems described herein.

While various methods, systems and examples described herein have been discussed with respect to OMA BCAST protocols, it is to be understood that a variety of broadcast and transmission protocols may be used in similar fashion. For example, a temporary tag may be configured according to a format compatible with an alternate broadcast protocol. In another example, one or more other parameters may be replaced (e.g., instead of a source tag parameter) depending on the specifications and compatibility of the broadcast protocol used.

The methods and features recited herein may further be implemented through any number of computer readable media that are able to store computer readable instructions. Examples of computer readable mediums that may be used include RAM, ROM, EEPROM, flash memory or other memory technology, CD-ROM, DVD or other optical disk storage, magnetic cassettes, magnetic tape, magnetic storage and the like.

Additionally or alternatively, in at least some embodiments, the methods and features recited herein may be implemented through one or more integrated circuits (ICs). An integrated circuit may, for example, be a microprocessor that accesses programming instructions and/or other data stored in a read only memory (ROM). In some such embodiments, ROM stores programming instructions that cause IC to perform operations according to one or more of the methods described herein. In at least some other embodiments, one or more the methods described herein are hardwired into IC. In other words, IC is in such cases an application specific integrated circuit (ASIC) having gates and other logic dedicated to the calculations and other operations described herein. In still other embodiments, IC may perform some operations based on execution of programming instructions read from ROM and/or RAM, with other operations hardwired into gates and other logic of IC. Further, IC may output image data to a display buffer.

Although specific examples of carrying out the invention have been described, those skilled in the art will appreciate that there are numerous variations and permutations of the above-described systems and methods that are contained within the spirit and scope of the invention as set forth in the appended claims. Additionally, numerous other embodiments, modifications and variations within the scope and spirit of the appended claims will occur to persons of ordinary skill in the art from a review of this disclosure.

We claim:

1. A method comprising:
configuring a broadcast session for transmitting a pseudo widget as an interactive component of said broadcast session, the pseudo widget configured to convey a broadcast program to a receiving device;
receiving the pseudo widget, wherein the pseudo widget includes temporary information configured to be replaced by the receiving device; and
notifying the receiving device that the pseudo widget is available.

2. The method of claim 1, wherein the temporary information is configured to be replaced with valid content source information for access the broadcast program.

3. The method of claim 1, wherein the temporary information comprises content identification information corresponding to the broadcast program.

4. The method of claim 3, wherein the temporary information includes a tag indicator for identifying the temporary information as temporary.

5. The method of claim 1, wherein the broadcast session is an Open Mobile Alliance Mobile Broadcast Services Enabler Suite broadcast session.

6. The method of claim 5, wherein the pseudo widget is transmitted as an instance of a MediaObjectSet element of the broadcast session.

7. The method of claim 1, further comprising:
defining a content fragment for the broadcast program and an interactive data fragment for the pseudo widget; and
associating the content fragment with the interactive data fragment.

8. A method comprising:
determining a content item corresponding to a widget, wherein the widget is configured to deliver the content item to a receiving device;
storing, in a pseudo widget corresponding to the widget, temporary information configured to be replaced at the receiving device, the temporary information further configured to identify the content item; and
transmitting the pseudo widget to a broadcast service system.

9. The method of claim 8, wherein the temporary information includes a matching field specifying an attribute of the content item that is to be matched.

10. The method of claim 9, wherein the matching field is a content identification field.

11. The method of claim 8, further comprising determining a timing for transmitting the widget in a broadcast session.

12. A method comprising:
receiving service guide information for a broadcast service broadcasting a content program;
determining whether interactive data exists for the broadcast program;
in response to determining that interactive data exists for the broadcast program, determining whether the interactive data includes a pseudo widget;
in response to determining that the interactive data includes the pseudo widget, receiving the pseudo widget corresponding to the content program;
extracting temporary information identifying the content program stored in the pseudo widget;
determining access information for accessing the content program based on the temporary information; and
converting the pseudo widget into a functional widget by replacing the temporary information in the pseudo widget with the determined access information.

13. The method of claim 12, wherein determining the access information for accessing the content program includes:
locating, in the broadcast service, a content fragment corresponding to the temporary information;
identifying an access fragment corresponding to the content fragment; and
converting access data in the access fragment from a first format to a second format.

14. The method of claim 12, further comprising executing the widget.

15. The method of claim 12, wherein the temporary information includes a matching field and a field value.

16. The method of claim 12, wherein determining access information for accessing the content program based on the temporary information includes:
determining whether a matching field is included in the temporary information; and
in response to determining that the matching field is not included in the temporary information, determining the access information based on an association between an access fragment associated the content program and an interactivity fragment corresponding to the pseudo widget.

17. An apparatus comprising:
a processor; and
memory configured to store computer readable instructions that, when executed by the processor, cause the processor to perform a method comprising:
configuring a broadcast session for transmitting a pseudo widget as an interactive component of said broadcast session, the pseudo widget configured to convey a broadcast program to a receiving device;
receiving the pseudo widget, wherein the widget includes temporary information configured to be replaced by the receiving device; and
notifying the receiving device that the pseudo widget is available.

18. The apparatus of claim 17, wherein the temporary information comprises content identification information corresponding to the broadcast program.

19. The apparatus of claim 17, further comprising instructions for:
defining a content fragment for the broadcast program and an interactive data fragment for the pseudo widget; and
associating the content fragment with the interactive data fragment.

20. The apparatus of claim 17, wherein the temporary information comprises content identification information corresponding to the broadcast program.

21. An apparatus comprising:
a processor; and
memory configured to store computer readable instructions that, when executed by the processor, cause the processor to perform a method comprising:
receiving service guide information for a broadcast service broadcasting a content program;
determining whether interactive data exists for the broadcast program;
in response to determining that interactive data exists for the broadcast program, determining whether the interactive data includes a pseudo widget,
in response to determining that the interactive data includes the pseudo widget, receiving the pseudo widget corresponding to the content program;
extracting temporary information identifying the content program stored in the pseudo widget;
determining access information for accessing the content program based on the temporary information; and
converting the pseudo widget into a functional widget by replacing the temporary information in the pseudo widget with the determined access information.

22. The apparatus of claim 21, further comprising instructions for executing the functional widget at a predefined time.

23. The apparatus of claim 21, wherein the temporary information includes a matching field specifying an attribute of the content program to be matched.

24. The apparatus of claim 21, wherein determining access information for accessing the content program based on the temporary information includes:
determining whether a matching field is included in the temporary information, wherein the matching field specified an attribute of the content program to be matched; and
in response to determining that the matching field is not included in the temporary information, determining the access information based on an association between an access fragment associated the content program and an interactivity fragment corresponding to the pseudo widget.
